(19) United States
(12) Patent Application Publication
(10) Pub. No.: US 2025/0141619 A1
(43) Pub. Date: May 1, 2025

(54) COMMUNICATION APPARATUS, COMMUNICATION METHOD, AND STORAGE MEDIUM

(71) Applicant: CANON KABUSHIKI KAISHA, Tokyo (JP)

(72) Inventors: EIGORO INA, Kanagawa (JP); Arisa Hirayama, Osaka (JP)

(21) Appl. No.: 19/011,236

(22) Filed: Jan. 6, 2025

Related U.S. Application Data
(63) Continuation of application No. PCT/JP2023/023253, filed on Jun. 23, 2023.

(30) Foreign Application Priority Data
Jul. 14, 2022 (JP) 2022-113309

(51) Int. Cl. H04L 5/00; H04L 27/26

(52) U.S. Cl. CPC H04L 5/0048; H04L 5/0046; H04L 27/2692

(57) ABSTRACT

A communication apparatus communicates a physical (PHY) frame including a preamble and a data field. The preamble includes an L-STF, an L-LTF, an L-SIG, an RL-SIG, a U-SIG, an HR-SIG, an HR-STF, and an HR-LTF, and the U-SIG includes four or more sub-fields configured to indicate that the communication apparatus communicates in a frequency band exceeding 320 MHz.

### CROSS-REFERENCE TO RELATED APPLICATIONS

This application is a Continuation of International Patent Application No. PCT/JP2023/023253, filed Jun. 23, 2023, which claims the benefit of Japanese Patent Application No. 2022-113309, filed Jul. 14, 2022, both of which are hereby incorporated by reference herein in their entirety.

### BACKGROUND

### Technical Field

The present disclosure relates to a technology for controlling communication on wireless local area networks (wireless LANs).

### Background Art

In recent years, as information and communication technology has advanced, internet usage has increased year by year, and various communication technologies are being developed to meet this growing demand. Among these, wireless local area network (wireless LAN) technology has led to improvements in throughput for internet communications, including packet data, voice, and video, through wireless LAN terminals, and various technological developments are currently ongoing.

In the advancement of wireless LAN technology, numerous standardization efforts by the Institute of Electrical and Electronics Engineers (IEEE) 802 within a standardization organization for wireless LAN technology have played a crucial role (Japanese Patent Application Laid-Open No. 2018-50133). The IEEE 802.11 standards are known as one of wireless LAN communication standards, and there are IEEE 802.11n/a/b/g/ac/ax/be. Further, the successor standard to IEEE 802.11be is considering a maximum frequency bandwidth of 640 MHz for further improvements in throughput. The frequency bandwidths conventionally used in wireless LAN are the following five bandwidths: 20 MHz, 40 MHz, 80 MHz, 160 MHz, and 320 MHz (Japanese Patent Application Laid-Open No. 2018-50133).

As described above, the successor standard to IEEE 802.11be is considering the use of a 640 MHz frequency bandwidth. However, previous standards for wireless LANs do not define systems for providing notifications that communication is performed in a frequency bandwidth exceeding 320 MHz.

### SUMMARY

The present disclosure is developed with consideration of the above-described issue and directed to a system for providing notifications that communication is performed in a frequency bandwidth exceeding 320 MHz.

To solve the issue, a communication apparatus according to the present disclosure includes a communication unit configured to communicate a physical (PHY) frame including a preamble and a data field, the preamble including a Legacy Short Training Field (L-STF), a Legacy Long Training Field (L-LTF) placed immediately after the L-STF in the frame, a Legacy Signal Field (L-SIG) placed immediately after the L-LTF in the frame, a Repeated Legacy Signal Field (RL-SIG) placed after the L-SIG in the frame, a Universal Signal Field (U-SIG) placed immediately after the RL-SIG in the frame, an HR Signal Field (HR-SIG) placed immediately after the U-SIG in the frame, an HR Short Training Field (HR-STF) placed immediately after the HR-SIG in the frame, and an HR Long Training Field (HR-LTF) placed immediately after the HR-STF in the frame, and the U-SIG includes one or more sub-fields configured to indicate that the communication apparatus communicates in a frequency band exceeding 320 MHz.

Further features of the present invention will become apparent from the following description of exemplary embodiments with reference to the attached drawings.

### BRIEF DESCRIPTION OF THE DRAWINGS

The attached drawings are included in the specification, constitute part of the specification, illustrate exemplary embodiments of the present invention, and are used, along with the descriptions thereof, to describe the principles of the present invention.

FIG. 1 is a diagram illustrating an example of a network configuration.

FIG. 2 is a diagram illustrating an example of a functional configuration of an access point (AP).

FIG. 3 is a diagram illustrating an example of a configuration of frequency bands used for wireless communication.

FIG. 4 is a flowchart illustrating a process performed by an AP.

FIG. 5 is a sequence diagram illustrating processes performed in a wireless communication network.

FIG. 6 is a diagram illustrating an example of a physical (PHY) frame structure in a High Reliability (HR) Multi-User (MU) Physical Layer Convergence Protocol (PLCP) Protocol Data Unit (PPDU).

FIG. 7 is a diagram illustrating an example of a PHY frame structure in an HR Trigger-Based (TB) PPDU.

### DESCRIPTION OF THE EMBODIMENTS

Exemplary embodiments will be described in detail below with reference to the attached drawings. The following exemplary embodiments are not intended to limit the claimed invention. While the exemplary embodiments describe a plurality of features, not all of the plurality of features are necessarily essential to the invention. Further, the plurality of features may be combined as desired. Further, in the attached drawings, identical or similar configurations are assigned the same reference number, and redundant descriptions thereof are omitted below.

### (Network Configuration)

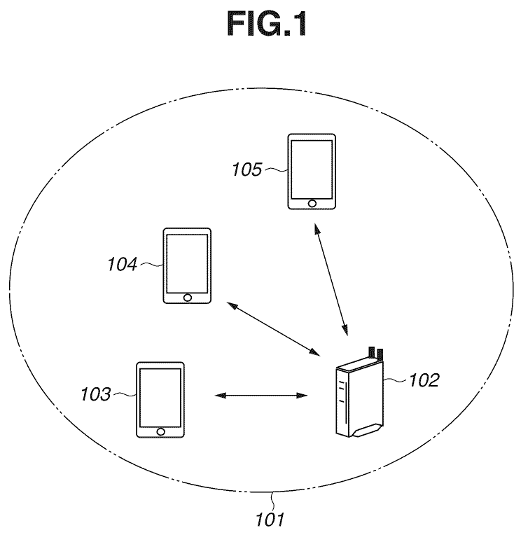

FIG. 1 illustrates an example of a configuration of a wireless communication network according to the present exemplary embodiment. The wireless communication network includes one access point (AP 102) and three stations (STA 103, STA 104, STA 105) as devices (high reliability (HR) devices) compliant with the Institute of Electrical and Electronics Engineers (IEEE) 802.11 HR standard. Further, IEEE 802.11 HR is a successor standard to the IEEE 802.11be standard aiming for a maximum transmission speed of 46.08 Gbps. The access point AP 102 and the station STA 103 are configured to perform wireless communication compliant with IEEE 802.11 HR aiming for a maximum transmission speed of 90 Gbps to 100 Gbps or higher. The successor standard to IEEE 802.11be sets a new goal of achieving high-reliability, low-latency communication. Considering the factors described above, the provisional name “IEEE 802.11 HR (High Reliability)” is used to refer to the successor standard to IEEE 802.11be aiming for a maximum transmission speed of 90 Gbps to 100 Gbps or higher in the present exemplary embodiment.

The name “IEEE 802.11 HR” is provisionally established for convenience, taking into account the goals to be achieved by the successor standard and the key features of the standard, and may be changed to another name when the standard is finalized. Meanwhile, it should be noted, essentially, that the present specification and the attached claims are applicable to all successor standards of the IEEE 802.11be standard that may support wireless communication.

The access point AP 102 can be considered a type of STA because it has similar functions to those of the stations STA 103 to 105, except for having a relay function. Stations STA within a circle 101 indicating a range within which signals transmitted from the access point AP 102 reach can communicate with the access point AP 102. The access point AP 102 communicates with the stations STA 103 to 105 using a wireless communication method of the IEEE 802.11 HR standard. The access point AP 102 can establish wireless links with the stations STA 103 to 105 through a connection process, such as an association process, in compliance with the IEEE 802.11 series standards.

The wireless communication network configuration illustrated in FIG. 1 is merely an example for explanation and, for example, a network covering an even broader area that includes numerous HR devices and legacy devices (communication apparatuses compliant with the IEEE 802.11a/b/g/n/ax/be standards) may be configured. Further, the following discussion is not limited to the arrangement of communication apparatuses illustrated in FIG. 1 and can also apply to various positional relationships of communication apparatuses.

### (Configuration of AP)

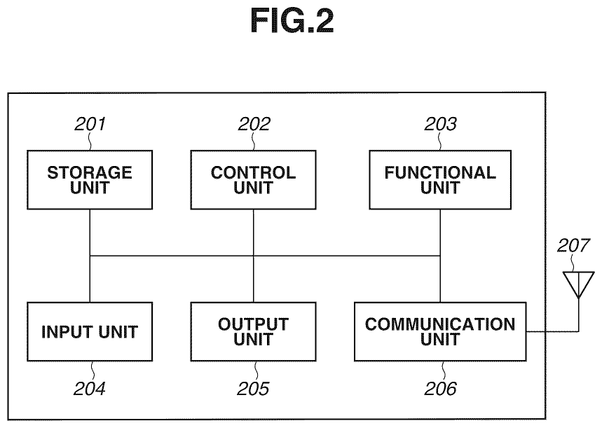

FIG. 2 is a block diagram illustrating a functional configuration of the access point AP 102. The access point AP 102 includes, as an example of its functional configuration, a wireless local area network (wireless LAN) control unit 201, a frame generation unit 202, a signal analysis unit 203, and a user interface (UI) control unit 204.

The wireless LAN control unit 201 may be configured to include one or more antennas 205 and a circuit for transmitting and receiving wireless signals (wireless frames) to and from other wireless LAN apparatuses and programs for controlling the one or more antennas 205 and the circuit. The wireless LAN control unit 201 controls wireless LAN communication using frames generated by the frame generation unit 202 in accordance with the IEEE 802.11 series standards.

The frame generation unit 202 generates a frame to be transmitted by the wireless LAN control unit 201 based on the result of analysis performed by the signal analysis unit 203 on the signal received by the wireless LAN control unit 201. The frame generation unit 202 may generate a frame independently of the analysis results from the signal analysis unit 203. The signal analysis unit 203 analyzes signals received by the wireless LAN control unit 201. The UI control unit 204 receives operations on an input unit 304 (FIG. 2) by a user (not illustrated) of the access point AP 102 and performs control to transmit control signals corresponding to the operations to the components or to output (including display) the control signals to an output unit 305 (FIG. 2).

FIG. 2 illustrates a hardware configuration of the access point AP 102 according to the present exemplary embodiment. The access point AP 102 includes, as an example of its hardware configuration, a storage unit 301, a control unit 302, a functional unit 303, the input unit 304, the output unit 305, a communication unit 306, and the one or more antennas 207.

The storage unit 301 is composed of a read-only memory (ROM), a random access memory (RAM), or both and stores programs for performing various operations described below and various types of information, such as communication parameters, for wireless communication. For the storage unit 301, a storage medium such as a flexible disk, a hard disk, an optical disk, a magneto-optical disk, a compact disc (CD)-ROM, a CD-recordable (CD-R), a magnetic tape, a non-volatile memory card, or a digital versatile disc (DVD) may be used, in addition to a memory such as a ROM or a RAM.

The control unit 302 is composed of, for example, a processor, such as a central processing unit (CPU) or a micro-processing unit (MPU), an application-specific integrated circuit (ASIC), a digital signal processor (DSP), and/or a field-programmable gate array (FPGA). The control unit 302 controls the entire access point AP 102 by executing programs stored in the storage unit 301. The control unit 302 may control the entire access point AP 102 through collaboration of the programs stored in the storage unit 301 and an operating system (OS).

Further, the control unit 302 controls the functional unit 303 to perform predetermined processes, such as imaging, printing, and projecting. The functional unit 303 is hardware used to perform the predetermined processes by the access point AP 102. For example, in cases where the access point AP 102 is a camera, the functional unit 303 is an imaging unit and performs an imaging process. Further, for example, in cases where the access point AP 102 is a printer, the functional unit 303 is a printing unit and performs a printing process. Further, for example, in cases where the access point AP 102 is a projector, the functional unit 303 is a projecting unit and performs a projecting process. The functional unit 303 may process data stored in the storage unit 301 or data communicated from a station STA or another access point AP via the communication unit 306 described below.

The input unit 304 receives various operations from the user. The output unit 305 provides various outputs to the user. The outputs provided by the output unit 305 herein include at least one of a display on a screen, audio output through a speaker, and vibration output. The input unit 304 and the output unit 305 may be realized by a single module, such as a touch panel.

The communication unit 306 controls wireless communication compliant with the IEEE 802.11 HR standard, Wi-Fi-compliant wireless communication, and Internet Protocol (IP) communication. Further, the communication unit 306 controls the one or more antennas 207 to transmit and receive wireless signals for wireless communication. In this case, multi-input multi-output (MIMO) communication utilizing spatial streams is enabled. The access point AP 102 communicates content, such as image data, document data, or video data, with other communication apparatuses via the communication unit 306.

### (Configuration of STA)

The stations STA 103 to 105 have functional and hardware configurations similar to the functional configuration (FIG. 2) and the hardware configuration (FIG. 2) of the access point AP 102 and each include the following functional configuration. Specifically, each of the stations STA 103 to 105 may be configured to include the wireless LAN control unit 201, the frame generation unit 202, the signal analysis unit 203, and the UI control unit 204 and include, as its hardware configuration, the storage unit 301, the control unit 302, the functional unit 303, the input unit 304, the output unit 305, the communication unit 306, and the one or more antennas 205.

### (Process Flow)

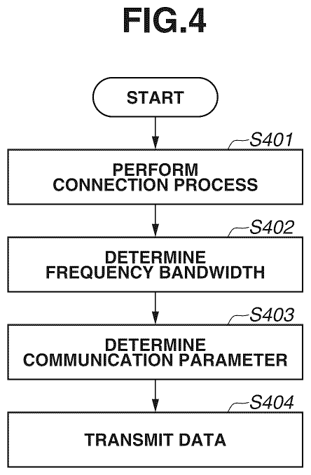

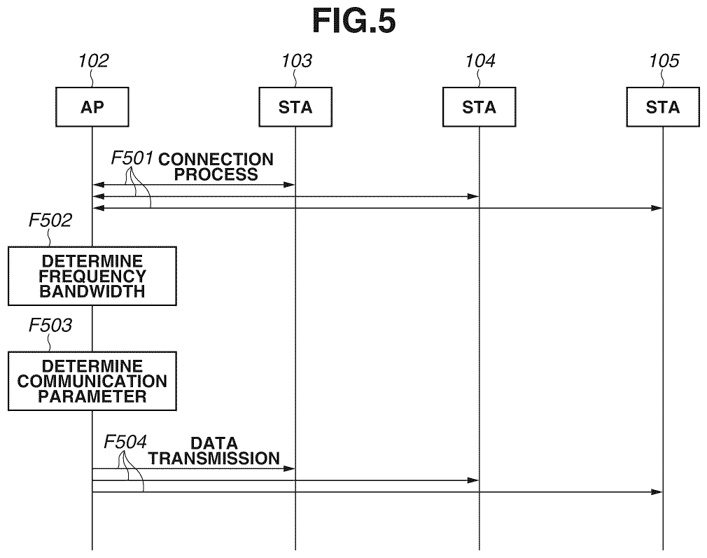

Next, a flow of a process performed by the access point AP 102 configured as described above and a sequence of a process performed by the wireless communication system illustrated in FIG. 1 will be described below with reference to FIGS. 4 and 5. FIG. 4 is a flowchart illustrating a process performed by the access point AP 102.

The flowchart illustrated in FIG. 4 may be realized by the control unit 302 of the access point AP 102 through execution of control programs stored in the storage unit 301, information computation and processing, and hardware control. Further, FIG. 5 is a sequence chart illustrating a process performed by the wireless communication system.

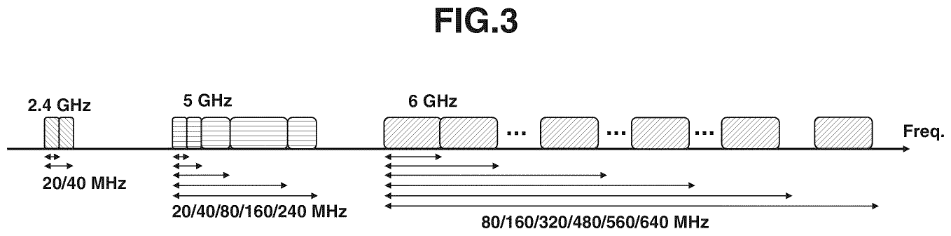

Prior to the description of FIGS. 4 and 5, a configuration of frequency bands used for wireless communication according to the present exemplary embodiment will be described below with reference to FIG. 3. FIG. 3 illustrates an example of frequency bands used for wireless communication. In the 2.4 GHz band, conventionally used for wireless LANs, the available frequency bandwidths are 20 MHz or 40 MHz. Further, in the 5 GHz band, also conventionally used for wireless LANs, the available frequency bandwidths are 20 MHz, 40 MHz, 80 MHz, and 160 MHz. IEEE 802.11 HR is also considering an extension to a 240 MHz bandwidth in the 5 GHz band. In contrast, in the 6 GHz band (from 5.925 GHz to 7.125 GHz), 80 MHz, 160 MHz, 320 MHz, 480 MHz, 560 MHz, and 640 MHz are being considered as available frequency bandwidths. The frequency bands in the 6 GHz band may be used not only in the IEEE 802.11 HR standard but also in IEEE 802.11x.

In steps S401 and F501 in FIGS. 4 and 5, the access point AP 102 performs a connection process on the stations STA 103 to 105 in accordance with the IEEE 802.11 series standards. Specifically, wireless links are established through the transmission and reception of frames, such as Probe Request/Response (probe request/response), Association Request/Response (association request/response), and Auth (authentication) frames, between the access point AP 102 and each of the stations STA 103 to 105. Then, in steps S402 and F502, the access point AP 102 determines a frequency bandwidth to be used for wireless communication. The frequency bandwidth may be determined as a bandwidth preset in the wireless communication system. Further, the frequency bandwidth may be determined through an operation on the input unit 304 by the user (not illustrated) of the access point AP 102.

Next, in steps S403 and F503, the access point AP 102 determines communication parameters, including the frequency bandwidth determined in steps S402 and F502, to be included in the wireless frames for transmission. Then, the access point AP 102 transmits data in the form of wireless frames including the determined transmission data communication parameters and the data to the stations STA 103 to 105.

### (Frame Structure)

A Universal Signal Field (U-SIG) included in an Extremely High Throughput (EHT) Multi-User (MU) Physical Layer Convergence Protocol (PLCP) Protocol Data Unit (EHT MU PPDU), as defined by the IEEE 802.11be standard, will be described below with reference to Tables 1 and 2.

The U-SIG consists of two symbols (U-SIG1 and U-SIG2), and each symbol stores 25 bits of information. Table 1 presents a format of U-SIG1, and Table 2 presents a format of U-SIG2.

TABLE 1
U-SIG1 field of an EHT MU PPDU (GEN7 MU PPDU)

| U-SIG | Bit Position | Sub-field | Number of Bits | Description |
|---|---|---|---|---|
| U-SIG1 | B0-B2 | PHY Version | 3 | Information that distinguishes PHY clauses |
| | | Identifier | | 0 for ETH (GEN7), or 1 for GEN8 |
| | B3-B5 | Bandwidth | 3 | 0 for 20 MHz, 1 for 40 MHz, 2 for 80 MHz, 3 for 160 MHz, |
| | | | | 4 for 320 MHz-1, 5 for 320 Mhz-2. |
| | | | | The values of 6 and 7 are reserved |
| | B6 | UL/DL | 1 | Information that indicates whether PPDU is for UL or DL |
| | B7-B12 | BSS Color | 6 | 6-bit number for identifying BSS |
| | B13-B19 | TXOP | 7 | Transmission Opportunity |
| | | | | 127 in cases where TXOP_DURATION of TXVECTOR is |
| | | | | UNSPECIFIED and there is no duration information. |
| | | | | Set to a value less than 127 to set NAV. At this time, if |
| | | | | TXOP_DURATION of TXVECTOR is less than 512, set a |
| | | | | value obtained by doubling the floor (rounded down) of |
| | | | | TXOP DURATION/8. Otherwise, set a value obtained by |
| | | | | doubling the floor of (TXOP_DURATION − 512)/128 and |
| | | | | then adding 1 to the result. |
| | B20-B24 | Disregard | 5 | Set to 1 for all to be treated as Disregard. |
| | B25 | Validate | 1 | Reserved |

The IEEE 802.11be standard specifies that the EHT MU PPDU is transmitted over the frequency bandwidth defined in the Bandwidth field of U-SIG-1. Further, the IEEE 802.11be standard defines the 320 MHz frequency bandwidths centered around channels 31, 95, and 159 as the 320-1 MHz frequency bandwidth. Furthermore, the 320 MHz frequency bandwidths centered around channels 63, 127, and 191 are defined as 320-2 MHz. In cases where “4” is stored in the Bandwidth field, it indicates that the EHT MU PPDU is transmitted over the 320-1 MHz frequency bandwidth. Further, in cases where “5” is stored in the Bandwidth field, it indicates that the EHT MU PPDU is transmitted over the 320-2 MHz frequency bandwidth.

TABLE 2
U-SIG2 field of an EHT MU PPDU (GEN7 MU PPDU)

| U-SIG | Bit Position | Sub-field | Number of Bits | Description |
|---|---|---|---|---|
| U-SIG2 | B0-B1 | PPDU Type And | 3 | In cases where 0 is set in UL/DL field: |
| | | Compression Mode | | 0 for DL OFDMA transmission, 1 for single |
| | | | | user transmission or ETH sounding NDP |
| | | | | transmission, 2 for non-OFDMA DL MU- |
| | | | | MIMO transmission, and 3 is a reserved value. |
| | | | | In cases where 1 is set in UL/DL field: |
| | | | | 1 for single user transmission or ETH |
| | | | | sounding NDP transmission, and 2 and 3 are |
| | | | | reserved values. |
| | | | | Note: 0 is a value representing TB PPDU in |
| | | | | cases where PPDU is TB PPDU. |
| | B2 | Validate | 1 | Set to 1 to be treated as a reserved value. |
| | B3-B7 | Punctured | 5 | In cases where 1 is set in [PPDU Type And |
| | | Channel Information | | Compression Mode] field regardless of the |
| | | | | value in [UL/DL] field, or in cases where 2 is |
| | | | | set in [PPDU Type And Compression Mode] |
| | | | | field and 0 is set in [UL/DL] field: |
| | | | | it represents Puncturing information about |
| | | | | non-OFDMA transmission. |
| | | | | In cases where 0 is set in [PPDU Type And |
| | | | | Compression Mode] field and 0 is set in |
| | | | | [UL/DL] field: |
| | | | | (1) in cases where a value of 2 to 5 indicating |
| | | | | 80 MHz, 160 MHz, or 320 MHz PPDU is set |
| | | | | in [Bandwidth] field, B3 to B6 represent a 4- |
| | | | | bit bitmap indicating 20-MHz sub-channels |
| | | | | punctured in an 80 MHz frequency sub-block |
| | | | | in which U-SIG processing is executed. |
| | | | | The 4-bit bitmap is indexed by 20 MHz sub- |
| | | | | channels in ascending order, and B3 |
| | | | | represents the 20 MHz sub-channel with the |
| | | | | lowest frequency. |
| | | | | For each of B3 to B6, 0 indicates that the |
| | | | | corresponding 20 MHz channel is punctured, |
| | | | | and 1 indicates otherwise. The permitted |
| | | | | puncture patterns(B3 to B6) for the 80 MHz |
| | | | | frequency sub-block are 1111 (no puncture), |
| | | | | 0111, 1011, 1101, 1110, 0011, 1100, and 1001. |
| | | | | (2) In cases where a value of 0 or 1 indicating |
| | | | | 20 MHz or 40 MHz PPDU is set in |
| | | | | [Bandwidth] field, set to 1 for B3 to B6. Other |
| | | | | values are reserved values. |
| | | | | Set to 1 for B7 to be treated as Disregard. |
| | B8 | Validate | 1 | Reserved |
| | B9-B10 | EHT-SIG MCS | 2 | MCS used for EHT-SIG modulation |
| | | | | 0 for EHT-MCS0, 1 for EHT-MCS1, 3 for |
| | | | | EHT-MCS3, 3 for EHT-MCS15 |
| | B11-B15 | Number Of EHT- | 5 | The number of EHT-SIG Symbols |
| | | SIG Symbols | | Set to a value obtained by subtracting 1 from |
| | | | | the number of EHT-SIG Symbols. |
| | B16-B19 | CRC | 4 | CRC of U-SIG (a total of 42 bits, consisting of |
| | | | | 26 bits of U-SIG1 and 16 bits up to 15 bits of |
| | | | | U-SIG2) field up to this point |
| | B20-B25 | Tail | 6 | Set to 0 to indicate termination in a |
| | | | | convolutional decoder |

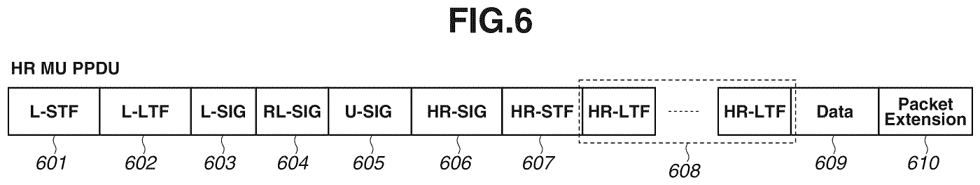

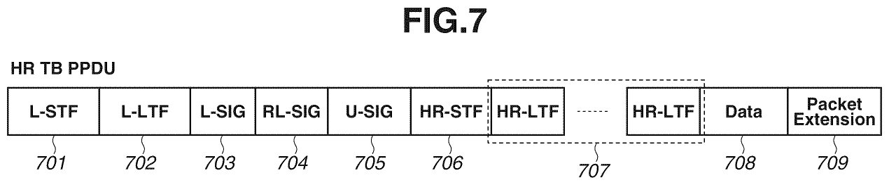

Next, FIGS. 6 and 7 illustrate examples of the structure of the PHY (physical) frame of the PPDU transmitted in steps S404 and F504, as defined in the IEEE 802.11 HR standard. FIG. 6 illustrates an example of the structure of a PHY frame of an HR MU PPDU for multi-user (MU) communication (between an access point AP and a plurality of stations STA).

FIG. 7 illustrates an example of the structure of a PHY frame of an HR Trigger-Based (TB) PPDU without HR-SIG, which is included in the HR MU PPDU.

In cases where the HR TB is used, communication resources are allocated to a plurality of stations STA using trigger frames. Therefore, no HR-SIG is included. The HR TB PPDU is used for communication between an access point AP and a plurality of stations STA.

The HR MU PPDU illustrated in FIG. 6 includes short training fields (STFs), long term fields (LTFs), and signal fields (SIGs). The header of the PPDU includes a Legacy-STF (L-STF) 601, a Legacy-LTF (L-LTF) 602, and a Legacy-SIG (L-SIG) 603, which are backward compatible with the IEEE 802.11a/b/g/n/ax/be standards. The L-STF 601 is used for PHY frame signal detection, automatic gain control (AGC), and timing detection. The L-LTF 602 placed immediately after the L-STF 601 is used for high-precision frequency and time synchronization and channel state information (CSI) acquisition. The L-SIG 603 placed immediately after the L-LTF 602 is used for transmission of control information including data transmission rate information and PHY frame length information. Legacy devices compliant with the IEEE 802.11a/b/g/n/ax/be standards are capable of decoding data from the various legacy fields (the L-STF 601, the L-LTF 602, the L-SIG 603).

Following the L-STF 601, the L-LTF 602, and the L-SIG 603, a repeated legacy signal field (RL-SIG) 604, a universal signal field (U-SIG) 605, a HR-SIG 606, a HR-STF 607, a HR-LTF 608, a data field 609, and a packet extension (Packet Extension) 610 are included.

The RL-SIG 604 is placed immediately after the L-SIG 603. The U-SIG 605 is placed immediately after the RL-SIG 604. The HR-SIG 606 is placed immediately after the U-SIG 605. Further, the HR-STF 607 is placed immediately after the HR-SIG 606, and the HR-LTF 608 is placed immediately after the HR-STF 607. The fields of the L-STF 601, the L-LTF 602, the L-SIG 603, the RL-SIG 604, the U-SIG 605, the HR-SIG 606, the HR-STF 607, and the HR-LTF 608 are referred to as the preamble. The U-SIG-605 includes essential information for PPDU reception, such as U-SIG-1 and U-SIG-2. Tables 3 and 4 present sub-fields that constitute the U-SIG-1 and the U-SIG-2 included in the U-SIG 605.

TABLE 3

| | Bit Position | Field | Number of Bits | Description |
|---|---|---|---|---|
| U-SIG-1 | B0-B2 | PHY Version Identifier | 3 | Information that distinguishes PHY clauses |
| | B3-B6 | Bandwidth | 4 | Set to 0 for 20 MHz. |
| | | | | Set to 1 for 40 MHz. |
| | | | | Set to 2 for 80 MHz. |
| | | | | Set to 3 for 160 MHz. |
| | | | | Set to 4 for 240 MHz. |
| | | | | Set to 5 for 320 MHz-1. |
| | | | | Set to 6 for 320 MHz-2. |
| | | | | Set to 7 for 480 MHz-1. |
| | | | | Set to 8 for 480 MHz-2. |
| | | | | Set to 9 for 560 MHz. |
| | | | | Set to 10 for 640 MHz. |
| | B7 | UL/DL | 1 | Information that indicates whether PPDU is for UL or DL |
| | B8-B13 | BSS Color | 6 | 6-bit number for identifying BSS |
| | B14-B20 | TXOP | 7 | Transmission Opportunity |
| | | | | 127 in cases where TXOP_DURATION of TXVECTOR is |
| | | | | UNSPECIFIED and there is no duration information. |
| | | | | Set to a value less than 127 to set NAV. At this time, if |
| | | | | TXOP_DURATION of TXVECTOR is less than 512, set a |
| | | | | value obtained by doubling the floor (rounded down) of |
| | | | | TXOP_DURATION/8. Otherwise, set a value obtained by |
| | | | | doubling the floor of (TXOP_DURATION − 512)/128 and |
| | | | | then adding 1 to the result. |
| | B21-B24 | Disregard | 4 | Set to 1 for all to be treated as Disregard. |
| | B25 | Validate | 1 | Set to 1 to be treated as Validate |

TABLE 4

| | Bit Position | Sub-field | Number of Bits | Description |
|---|---|---|---|---|
| U-SIG2 | B0-B1 | PPDU Type And | 3 | In cases where 0 is set in UL/DL field: |
| | | Compression Mode | | 0 for DL OFDMA transmission, 1 for single |
| | | | | user transmission or ETH sounding NDP |
| | | | | transmission, 2 for non-OFDMA DL MU- |
| | | | | MIMO transmission, and 3 is a reserved value. |
| | | | | In cases where 1 is set in UL/DL field: |
| | | | | 1 for single user transmission or ETH |
| | | | | sounding NDP transmission, and 2 and 3 are |
| | | | | reserved values. |
| | | | | Note: 0 is a value representing TB PPDU in |
| | | | | cases where PPDU is TB PPDU. |
| | B2 | Validate | 1 | Set to 1 to be treated as a reserved value. |
| | B3-B7 | Punctured Channel | 5 | In cases where 1 is set in [PPDU Type And |
| | | Information | | Compression Mode] field regardless of the |
| | | | | value in [UL/DL] field, or in cases where 2 is |
| | | | | set in [PPDU Type And Compression Mode] |
| | | | | field and 0 is set in [UL/DL] field: |
| | | | | it represents Puncturing information about |
| | | | | non-OFDMA transmission. |
| | | | | In cases where 0 is set in [PPDU Type And |
| | | | | Compression Mode] field and 0 is set in |
| | | | | [UL/DL] field: |
| | | | | (1) in cases where a value of 2 to 7 indicating |
| | | | | 80 MHz, 160 MHz, 320 MHz, 480 MHz, or |
| | | | | 640 MHz PPDU is set in [Bandwidth] field, |
| | | | | B3 to B6 represent a 4-bit bitmap indicating |
| | | | | 20-MHz sub-channels punctured in an 80 |
| | | | | MHz frequency sub-block in which U-SIG |
| | | | | processing is executed. |
| | | | | The 4-bit bitmap is indexed by 20 MHz sub- |
| | | | | channels in ascending order, and B3 |
| | | | | represents the 20 MHz sub-channel with the |
| | | | | lowest frequency. |
| | | | | For each of B3 to B6, 0 indicates that the |
| | | | | corresponding 20 MHz channel is punctured, |
| | | | | and 1 indicates otherwise. The permitted |
| | | | | puncture patterns(B3 to B6) for the 80 MHz |
| | | | | frequency sub-block are 1111 (no puncture), |
| | | | | 0111, 1011, 1101, 1110, 0011, 1100, and 1001. |
| | | | | (2) In cases where a value of 0 or 1 indicating |
| | | | | 20 MHz or 40 Mhz PPDU is set in |
| | | | | [Bandwidth] field, set to 1 for B3 to B6. Other |
| | | | | values are reserved values. |
| | | | | Set to 1 for B7 to be treated as Disregard. |
| | B8 | Validate | 1 | Reserved |
| | B9-B10 | HR-SIG MCS | 2 | MCS used for HR-SIG modulation |
| | B11-B15 | Number Of HR- | 5 | The number of HR-SIG Symbols |
| | | SIG Symbols | | Set to a value obtained by subtracting 1 from |
| | | | | the number of HR-SIG Symbols. |
| | B16-B19 | CRC | 4 | CRC of U-SIG (a total of 42 bits, consisting of |
| | | | | 26 bits of U-SIG1 and 16 bits up to 15 bits of |
| | | | | U-SIG2) field up to this point |
| | B20-B25 | Tail | 6 | Set to 0 to indicate termination in a |
| | | | | convolutional decoder |

The present exemplary embodiment is intended to use a maximum of 640 MHz as a frequency bandwidth exceeding 320 MHz, as described above with reference to FIG. 3. However, the Bandwidth sub-field only provides 3 bits, making it impossible to designate all available frequency bandwidths. Thus, the present exemplary embodiment extends the Disregard Field or Validate Field in the U-SIG-1 (Table 1) to use 1 bit. Therefore, 4 bits in total, including the Bandwidth sub-field in the U-SIG-1, are used to designate frequency bandwidths. The present exemplary embodiment describes an example in which “7” and “8”, which are described as ‘Validate’ in the Bandwidth field of the U-SIG-1 in the IEEE 802.11be standard, are used and the Disregard Field is extended. The differences from Table 1 specified in the IEEE 802.11be standard will be described below.

As illustrated in FIG. 3, IEEE 802.11 HR is also considering an extension to a 240 MHz bandwidth in the 5 GHz band. Thus, in cases where “4” is specified in the Bandwidth field of the U-SIG-1, it indicates that communication is performed in the 240 MHz frequency bandwidth.

Further, in cases where “5” is specified in the Bandwidth field of the U-SIG-1, it indicates that the HR MU PPDU is communicated in the 320-1 MHz frequency bandwidth. Similarly, in cases where “6” is specified in the Bandwidth field of the U-SIG-1, it indicates that the HR MU PPDU is communicated in the 320-2 MHz frequency bandwidth.

Further, as illustrated in FIG. 3, IEEE 802.11 HR is considering an extension from the 320 MHz frequency bandwidth to 480 MHz, 560 MHZ, and 640 MHz frequency bandwidths in the 6 GHz frequency band.

Thus, in cases where “7” is specified in the Bandwidth field of the U-SIG-1, it indicates that the HR MU PPDU is communicated in a 480-1 MHz frequency bandwidth. Similarly, in cases where “8” is specified in the Bandwidth field of the U-SIG-1, it indicates that the HR MU PPDU is communicated in a 480-2 MHz frequency bandwidth. Further, in cases where “9” is specified in the Bandwidth field of the U-SIG-1, it indicates that the HR MU PPDU is communicated in a 560 MHz frequency bandwidth. Similarly, in cases where “10” is specified in the Bandwidth field of the U-SIG-1, it indicates that the HR MU PPDU is communicated in the 640 MHz frequency bandwidth.

As described above, the HR TB PPDU in FIG. 7 has a PPDU structure without HR-SIG, which is included in the HR MU PPDU. In cases where the HR TB PPDU is used, communication resources are allocated to a plurality of stations STA using trigger frames. The HR TB PPDU includes an L-STF 701, an L-LTF 702, an L-SIG 703, an RL-SIG 704, a U-SIG 705, an HR-STF 706, an HR-LTF 707, a data field 708, and a packet extension 709.

The structure of the HR TB PPDU from the L-STF 701 to the U-SIG 705 is similar to that of the HR MU PPDU, so that descriptions thereof are omitted below.

The L-LTF 702 is placed immediately after the L-STF 701. The L-SIG 703 is placed immediately after the L-LTF 702. The RL-SIG 704 is placed after the L-SIG 703. Furthermore, the HR-STF 706 is placed immediately after the U-SIG 705, and the HR-LTF 707 is placed immediately after the HR-STF 706. The fields of the L-STF 701, the L-LTF 702, the L-SIG 703, the RL-SIG 704, the U-SIG 705, the HR-STF 706, and the HR-LTF 707 are referred to as the preamble.

The sub-fields that constitute U-SIG-1 and U-SIG-2 of the U-SIG 705 in the HR TB PPDU are similar to those in the HR MU PPDU, so that detailed descriptions there are omitted below.

In every PPDU used in the IEEE 802.11 HR standard, U-SIG-1 provides an area of 3 bits or more for frequency bandwidth designation as described above, making it possible to designate a frequency band exceeding 320 MHz.

While FIGS. 6 and 7 illustrate frame structures that are backward compatible with the IEEE 802.11a/b/g/n/ax/be standards, the L-STF and L-LTF fields may be omitted in cases where backward compatibility is not required. Instead, HR-STF and HR-LTF may be inserted.

TABLE 5

| | Bit Position | Field | Number of Bits | Description |
|---|---|---|---|---|
| U-SIG-1 | B0-B2 | PHY Version | 3 | Information that distinguishes PHY clauses |
| | | Identifier | | |
| | B3-B5 | Bandwidth-1 | 3 | Set to 0 for 20 MHz. |
| | | | | Set to 1 for 40 MHz. |
| | | | | Set to 2 for 80 MHz. |
| | | | | Set to 3 for 160 MHz. |
| | | | | Set to 4 for 320 MHz-1. |
| | | | | Set to 5 for 320 MHz-2. |
| | | | | 6 and 7 are Validate |
| | B6-B8 | Bandwidth-2 | 3 | Set to 0 for 240 MHz. |
| | | | | Set to 1 for 480 MHz-1. |
| | | | | Set to 2 for 480 MHz-2. |
| | | | | Set to 3 for 560 MHz. |
| | | | | Set to 4 for 640 MHz. |
| | B9 | UL/DL | 1 | Information that indicates whether PPDU is for UL or DL |
| | B10-B15 | BSS Color | 6 | 6-bit number for identifying BSS |
| | B16-B22 | TXOP | 7 | Transmission Opportunity |
| | | | | 127 in cases where TXOP_DURATION of TXVECTOR is |
| | | | | UNSPECIFIED and there is no duration information. |
| | | | | Set to a value less than 127 to set NAV. At this time, if |
| | | | | TXOP_DURATION of TXVECTOR is less than 512, set a |
| | | | | value obtained by doubling the floor (rounded down) of |
| | | | | TXOP_DURATION/8. Otherwise, set a value obtained by |
| | | | | doubling the floor of (TXOP_DURATION − 512)/128 and |
| | | | | then adding 1 to the result. |
| | B23-B24 | Disregard | 2 | Set to 1 for all to be treated as Disregard. |
| | B25 | Validate | 1 | Set to 1 to be treated as Validate |

Further, U-SIG-1 illustrated in Table 3 may be represented as shown in Table 5. In this case, U-SIG-2 is the same as shown in Table 4.

Table 5 illustrates the frequency bandwidths extended from the IEEE 802.11 HR standard in a Bandwidth-2 field, using 3 bits of Disregard in the U-SIG-1 field of the IEEE 802.11be standard, as illustrated in Table 1. The differences from Table 1 specified in the IEEE 802.11be standard will be described below. While Table 5 illustrates an example in which the Disregard field is extended, this is not a limitation. For example, a Validate field may be extended to specify the 240 MHz, 480 MHZ, 560 MHz, and 640 MHz frequency bandwidths extended from the IEEE 802.11 HR standard.

In Table 5, the Bandwidth-2 field may be enabled in cases where IEEE 802.11 HR is specified in a PHY Version Identifier field of U-SIG-1.

In cases where “0” is specified in the Bandwidth-2 field of U-SIG-1 in Table 5, it indicates that the HR MU PPDU is communicated in the 240 MHz frequency bandwidth. Similarly, in cases where “1” is specified in the Bandwidth-2 field of U-SIG-1, it indicates that the HR MU PPDU is communicated in the 480-1 MHz frequency bandwidth. Further, in cases where “2” is specified in the Bandwidth-2 field of U-SIG-1, it indicates that the HR MU PPDU is communicated in the 480-2 MHz frequency bandwidth. Similarly, in cases where “3” is specified in the Bandwidth-2 field of U-SIG-1, it indicates that the HR MU PPDU is communicated in the 560 MHz frequency bandwidth. Further, in cases where “4” is specified in the Bandwidth-2 field of U-SIG-1, it indicates that the HR MU PPDU is communicated in the 640 MHz frequency bandwidth.

Extending Disregard as described above makes it possible to specify the frequency bandwidths extended from the IEEE 802.11 HR standard.

The present disclosure makes it possible to provide notifications indicating that communication is performed in a frequency bandwidth exceeding 320 MHz.

The invention is not limited to the foregoing exemplary embodiments, and various changes and modifications are possible without departing from the spirit and scope of the invention. Therefore, claims are attached to disclose the scope of the invention.

The descriptions of standard names, such as IEEE 802.11 HR, and character string portions corresponding to a standard name and constituting a field name containing the same character string as the standard name, such as HR-SIG, HR-STF, and HR-LTF, are not limited to those described above. High Reliability (HR) is not a limitation. For example, High ReLiability (HRL1) may be used. Further, High Reliability Wireless (HRW) may be used. Further, Very High Reliability (VHT) may be used. Further, Extremely High Reliability (EHR) may be used. Further, Ultra High Reliability (UHR) may be used. Further, Low Latency (LL) may be used. Further, Very Low Latency (VLL) may be used. Further, Extremely Low Latency (ELL) may be used. Further, Ultra Low Latency (ULL) may be used. Further, High Reliable and Low Latency (HRLL) may be used. Further, Ultra-Reliable and Low Latency (URLL) may be used. Further, Ultra-Reliable and Low Latency Communications (URLLC) may be used. Further, other names may be used. For example, in cases where UHR is used, field names with character strings corresponding to the standard name, such as UHR-SIG, UHR-STF, UHR-LTF, and UHR-SIG MCS, are used.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A communication apparatus comprising:
at least one memory storing instructions; and
at least one processing circuit, wherein the communication apparatus is caused, by the at least one processing circuit executing the instructions and/or the at least one processing circuit itself operating, to perform communication of a physical (PHY) frame including a preamble and a data field,
the preamble including:
a Legacy Short Training Field (L-STF);
a Legacy Long Training Field (L-LTF) placed immediately after the L-STF in the frame;
a Legacy Signal Field (L-SIG) placed immediately after the L-LTF in the frame;
a Repeated Legacy Signal Field (RL-SIG) placed after the L-SIG in the frame;
a Universal Signal Field (U-SIG) placed immediately after the RL-SIG in the frame;
a Ultra High Reliability (UHR) Short Training Field (UHR-STF) placed after the U-SIG in the frame; and
a UHR Long Training Field (UHR-LTF) placed immediately after the UHR-STF in the frame,
wherein the U-SIG includes one or more sub-fields configured to indicate that the communication apparatus communicates in a frequency band exceeding 320 MHz.

2. The communication apparatus according to claim 1, wherein the number of bits included in the one or more subfields is 4 or more in total.

3. The communication apparatus according to claim 1, wherein the one or more sub-fields include a Disregard or Validate sub-field.

4. The communication apparatus according to claim 1, wherein the frame further includes a UHR Signal Field (HR-SIG) placed immediately after the U-SIG.

5. The communication apparatus according to claim 1, wherein the frequency band exceeding 320 MHz is 640 MHz.

6. The communication apparatus according to claim 1, wherein the sub-field is configured to indicate that communication is performed in a 480-1 MHz frequency bandwidth, and the sub-field is configured to indicate that communication is performed in a 480-2 MHz frequency bandwidth.

7. A communication method using a communication apparatus, the communication method comprising:
communicating a physical (PHY) frame including a preamble and a data field and being compliant with an Institute of Electrical and Electronics Engineers (IEEE) 802.11 Ultra High Reliability (UHR) standard,
the preamble including:
a Legacy Short Training Field (L-STF);
a Legacy Long Training Field (L-LTF) placed immediately after the L-STF in the frame;
a Legacy Signal Field (L-SIG) placed immediately after the L-LTF in the frame;
a Repeated Legacy Signal Field (RL-SIG) placed after the L-SIG in the frame;
a Universal Signal Field (U-SIG) placed immediately after the RL-SIG in the frame;
a UHR Short Training Field (UHR-STF) placed after the U-SIG in the frame; and
a UHR Long Training Field (UHR-LTF) placed immediately after the UHR-STF in the frame,
wherein the U-SIG includes one or more sub-fields configured to indicate that the communication apparatus communicates in a frequency band exceeding 320 MHz.

8. A non-transitory computer readable storage medium storing a program to cause, when the program is executed by at least one processor, a communication apparatus to perform:
communication of a physical (PHY) frame including a preamble and a data field and being compliant with an IEEE 802.11 Ultra High Reliability (UHR) standard,
the preamble including:
a Legacy Short Training Field (L-STF);
a Legacy Long Training Field (L-LTF) placed immediately after the L-STF in the frame;
a Legacy Signal Field (L-SIG) placed immediately after the L-LTF in the frame;
a Repeated Legacy Signal Field (RL-SIG) placed after the L-SIG in the frame;
a Universal Signal Field (U-SIG) placed immediately after the RL-SIG in the frame;
a UHR Short Training Field (UHR-STF) placed after the U-SIG in the frame; and
a UHR Long Training Field (UHR-LTF) placed immediately after the UHR-STF in the frame,
wherein the U-SIG includes one or more sub-fields configured to indicate that the communication apparatus communicates in a frequency band exceeding 320 MHz.
